(19) United States
(12) Patent Application Publication
(10) Pub. No.: US 2025/0245918 A1
(43) Pub. Date: Jul. 31, 2025

(54) ELECTRONIC DEVICES FOR COOPERATIVE USE

(71) Applicant: Apple Inc., Cupertino, CA (US)

(72) Inventors: Paul X. WANG, Cupertino, CA (US); Jeremy C. FRANKLIN, San Francisco, CA (US)

(21) Appl. No.: 18/429,194

(22) Filed: Jan. 31, 2024

(51) Int. Cl. G06T 17/00; G06F 3/01; G06F 3/0482; G06T 7/70; G06V 10/44; G06V 10/60

(52) U.S. Cl. CPC G06T 17/00; G06F 3/012; G06F 3/0482; G06T 7/70; G06V 10/44; G06V 10/60

(57) ABSTRACT

Systems of the present disclosure can provide head-mountable devices and other electronic devices with different input and output capabilities. Such differences can lead the head-mountable devices and other electronic devices to provide the corresponding users with somewhat isolating experiences despite operating in a shared environment. However, the outputs provided by one head-mountable device or one electronic device can be shared on another device so that the users are aware of each other's experience. At least some content provided for output on one device can be transmitted to another device for output thereat. Such content can be provided in a manner that allows the user of the other electronic device to have a different perspective and/or experience with respect to the content.

### TECHNICAL FIELD

The present description relates generally to electronic devices, and, more particularly, to head-mountable devices and other electronic devices for cooperative use.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a front view of an electronic device, according to some embodiments of the present disclosure.

FIG. 3A illustrates a top view of a head-mountable device, according to some embodiments of the present disclosure.

FIG. 3B illustrates a rear view of the head-mountable device of FIG. 3A, each providing a user interface, according to some embodiments of the present disclosure.

FIG. 4A illustrates a view of a head-mountable device and an electronic device, according to some embodiments of the present disclosure.

FIG. 4B illustrates a view of a head-mountable device and an electronic device of FIG. 4A, each providing a user interface, according to some embodiments of the present disclosure.

FIG. 5 illustrates a top view of a head-mountable device and an electronic device, according to some embodiments of the present disclosure.

FIG. 6A illustrates a rear view of the head-mountable device and the electronic device of FIG. 5, each providing a user interface, according to some embodiments of the present disclosure.

FIG. 6B illustrates a rear view of the head-mountable device and the electronic device of FIGS. 5 and 6A, each providing a user interface, according to some embodiments of the present disclosure.

FIG. 6C illustrates a rear view of the head-mountable device and the electronic device of FIGS. 5-6B, each providing a user interface, according to some embodiments of the present disclosure.

FIG. 7 illustrates a top view of a head-mountable device and an electronic device, according to some embodiments of the present disclosure.

FIG. 8 illustrates a top view of the head-mountable device and the electronic device of FIG. 7, according to some embodiments of the present disclosure.

FIG. 9 illustrates a top view of the head-mountable device and the electronic device of FIGS. 7 and 8, according to some embodiments of the present disclosure.

FIG. 10 illustrates a flow chart for a process having operations performed by a head-mountable device, according to some embodiments of the present disclosure.

FIG. 11 illustrates a flow chart for a process having operations performed by an electronic device, according to some embodiments of the present disclosure.

FIG. 12 illustrates a top view of a head-mountable device and an electronic device, according to some embodiments of the present disclosure.

FIG. 13 illustrates a rear view of the head-mountable device and the electronic device of FIG. 12, each providing a user interface, according to some embodiments of the present disclosure.

FIG. 14 illustrates a flow chart for a process having operations performed by a head-mountable device, according to some embodiments of the present disclosure.

FIG. 15 illustrates a flow chart for a process having operations performed by an electronic device, according to some embodiments of the present disclosure.

FIG. 16 illustrates a block diagram of a head-mountable device or an electronic device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device. Other electronic devices can perform similar functions while providing a different type of user experience. Multiple electronic devices, including at least one head-mountable device, can operate in concert to provide multiple users with shared experiences and content enjoyment. Such operations can be facilitated by a connection between multiple head-mounted devices and/or other electronic devices to allow different users to receive content.

Given the diversity of desired components and functions across head-mountable devices and other electronic devices, it would be beneficial to provide functions that help users understand each other's experience. This can allow the users to have more similar experiences while operating in a shared environment. It can also be beneficial to allow multiple electronic devices to operate in concert to leverage their combined sensory input and computing power, as well as those of other external devices to improve sensory perception, mapping ability, accuracy, and/or processing workload.

Systems of the present disclosure can provide head-mountable devices and other electronic devices with different input and output capabilities. Such differences can lead the head-mountable devices and other electronic devices to provide the corresponding users with somewhat isolating experiences despite operating in a shared environment. However, the outputs provided by one head-mountable device or one electronic device can be shared and/or enhanced on another device so that the users are aware of the characteristics of each other's experience.

At least some content provided for output on one device can be transmitted to another device for output thereat. Such content can be provided in a manner that allows the user of the other electronic device to have a different perspective and/or experience with respect to the content. The connection can facilitate such transmission in a manner that reduces the burden of generating content and/or adapting content for output on any given device. The distribution and/or focus of workload and sharing of processed information can lead to greatly improved power management and heat generation at one or more of the devices.

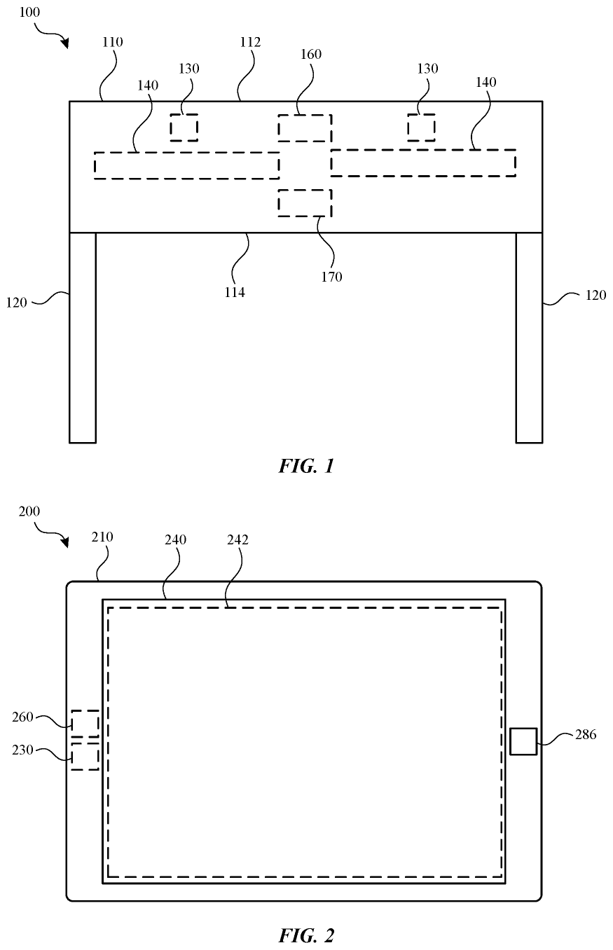

These and other embodiments are discussed below with reference to FIGS. 1-16. However, those skilled in the art will readily appreciate that the detailed description given herein with respect to these Figures is for explanatory purposes only and should not be construed as limiting.

FIG. 1 illustrates an example head-mountable device 100 that may be used in concert with an electronic device in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided. In one or more implementations, one or more components of the example head-mountable device 100 may be implemented on another device.

As shown in FIG. 1, a head-mountable device 100 can include a frame 110 and a head securement element 120. The frame 110 can be worn on a head of a user. The frame 110 can be positioned in front of the eyes of a user to provide information within a field of view of the user. The frame 110 can optionally provide a nosepiece to rest on a user's nose and/or other face engagement portions to rest against the user's face.

The frame 110 can be supported on a user's head with a head securement element 120. The head securement element 120 can wrap or extend along opposing sides of a user's head and/or to a rear of the user's head. The head securement element 120 can optionally include earpieces for wrapping around or otherwise engaging or resting on a user's ears. It will be appreciated that other configurations can be applied for securing the head-mountable device 100 to a user's head. For example, one or more bands, straps, belts, caps, hats, or other components can be used in addition to or in place of the illustrated components of the head-mountable device 100.

The frame 110 can provide structure around a peripheral region thereof to support any internal components of the head-mountable device 100 in their assembled position. For example, the frame 110 can enclose and support various internal components (including for example integrated circuit chips, processors, memory devices and other circuitry) to provide computing and functional operations for the head-mountable device 100, as discussed further herein. While several components are shown within the frame 110 of the head-mountable device 100, it will be understood that some or all of these components can be located anywhere within or on the head-mountable device 100. For example, one or more of these components can be positioned within the face engagement portions, the arms 190, and/or the head securement element 120 of the head-mountable device 100.

The head-mountable device 100 can include and/or support one or more cameras 130. The cameras 130 can be positioned on or near an outer side 112 of the frame 110 to capture images of views external to the head-mountable device 100. As used herein, an outer side of a portion of a head-mountable device is a side that faces away from the user and/or towards an external environment. The captured images can be used for display to the user or stored for any other purpose. Each of the cameras 130 can be movable along the outer side 112. For example, a track or other guide can be provided for facilitating movement of the camera 130 therein.

The head-mountable device 100 can include one or more sensors 160, which may include, for example, one or more image sensors (e.g., cameras 130), one or more depth sensors, one or more infrared sensors, one or more thermal (e.g., infrared) sensors, and/or generally any sensors that may be used to detect one or more characteristics of physical items in an external environment. The sensors 160 can be operated to detect another device, such as an electronic device. The sensors 160 can be operated to perform object detection and/or recognition.

The head-mountable device 100 can include displays 140 that provide visual output for viewing by a user wearing the head-mountable device 100. One or more displays 140 can be positioned on or near an inner side 114 of the frame 110. As used herein, an inner side 114 of a portion of a head-mountable device 100 is a side that faces toward the user and/or away from the external environment.

A display 140 can transmit light from a physical environment (e.g., as captured by a camera) for viewing by the user. Such a display 140 can include optical properties, such as lenses for vision correction based on incoming light from the physical environment. Additionally or alternatively, a display 140 can provide information as a display within a field of view of the user. Such information can be provided to the exclusion of a view of a physical environment or in addition to (e.g., overlaid with) a physical environment.

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations, (e.g., for accessibility reasons), adjustments to characteristic(s) of virtual object(s) in a CGR environment may be made in response to representations of physical motions (e.g., vocal commands).

A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects.

Examples of CGR include virtual reality and mixed reality.

A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.

In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality.

An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.

An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

There are many different types of electronic systems that enable a person to sense and/or interact with various CGR environments. Examples include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Each display 140 can be adjusted to align with a corresponding eye of the user. For example, each display 140 can be moved along one or more axes until a center of each display 140 is aligned with a center of the corresponding eye. Accordingly, the distance between the displays 140 can be set and/or changed based on an interpupillary distance (“IPD”) of the user. IPD is defined as the distance between the centers of the pupils of a user's eyes.

The frame 110 can include a user sensor 170. The user sensor 170 can be positioned and arranged to detect a characteristic of the user, such as facial features. For example, such a user sensor can perform facial feature detection, facial movement detection, facial recognition, eye tracking, user mood detection, user emotion detection, voice detection, and the like. By further example, the user sensor 170 can include an IMU, a depth sensor, a user input component (e.g., touch sensor, crown, touchpad, button, microphone, and the like).

The user sensor 170 can include an eye-tracking sensor that can track features of the user wearing the head-mountable device 100, including conditions of the user's eye (e.g., focal distance, pupil size, etc.). For example, an eye sensor can optically capture a view of an eye (e.g., pupil) and determine a direction of a gaze of the user. Such eye tracking may be used to determine a location and/or direction of interest with respect to the display 140 and/or elements presented thereon. Such information can be used as the basis of outputs for the head-mountable device 100 and/or another device, as described herein. For example, user interface elements can then be provided on the display 140 of the head-mountable device 100 and/or another device based on this information, for example in a region along the direction of the user's gaze or a region other than the current gaze direction, as described further herein. The detections made by the eye-tracking sensor can determine user actions that are interpreted as user inputs. Such user inputs can be used alone or in combination with other user inputs to perform certain actions. By further example, such sensors can perform facial feature detection, facial movement detection, facial recognition, user mood detection, user emotion detection, voice detection, and the like.

FIG. 2 illustrates an example electronic device 200 that may be used in concert with a head-mountable device in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided. In one or more implementations, one or more components of the example electronic device 200 may be implemented on another device.

The electronic device 200 can include and/or support one or more cameras 230. The cameras 230 can be positioned on or near an outer side of the electronic device 200 to capture images of views in front of the electronic device 200. As used herein, an outer side of a portion of an electronic device is a side that faces away from the user and/or towards an external environment. The captured images can be used for display to the user or stored for any other purpose.

The electronic device 200 can include one or more sensors 260, which may include, for example, one or more image sensors (e.g., cameras 230), one or more depth sensors, one or more infrared sensors, one or more thermal (e.g., infrared) sensors, and/or generally any sensors that may be used to detect one or more characteristics of physical items in an external environment. The sensors 260 can be operated to detect another device, such as a head-mountable device. The sensors 260 can be operated to perform object detection and/or recognition.

The electronic device 200 can include one or more displays 240 that provide visual output for viewing by a user holding or otherwise near the electronic device 200. The one or more cameras 230, the one or more sensors 260, and/or other components can be positioned at any portion of the electronic device 200 with respect to the display 240 to provide detection capabilities with respect to any portion of an external environment.

The electronic device 200 can include a user input device 286.

The first head-mountable device 100 can include an input component 186 and/or output component 184, which can include any suitable component for receiving user input, providing output to a user, and/or connecting head-mountable device 100 to other devices. The input component 186 can include buttons, keys, or another feature that can act as a keyboard for operation by the user. Other suitable components can include, for example, audio/video jacks, data connectors, or any additional or alternative input/output components.

The electronic device 200 may be, for example, a tablet, a phone, a laptop computing device, a desktop computing device, a wearable device, a mobile computing device, a tablet computing device, a display, a television, a digital media player, a head-mountable device, any other electronic device, and/or other appropriate devices that include one or more sensors, such as cameras, infrared sensors, depth sensors, thermal (e.g., infrared) sensors, and the like, and/or that include one or more wired or wireless communication interfaces, such as one or more universal serial bus (USB) interfaces, near-field communication (NFC) radios, wireless local area network (WLAN) radios, Bluetooth® radios, Zigbee® radios, cellular radios, and/or other wireless radios. In some embodiments, by way of example, the electronic device 200 is depicted as a tablet device. An example electronic device 200 may be, and/or may include all or part of, the electronic device discussed below with respect to FIG. 2 and/or the system discussed below with respect to FIG. 18.

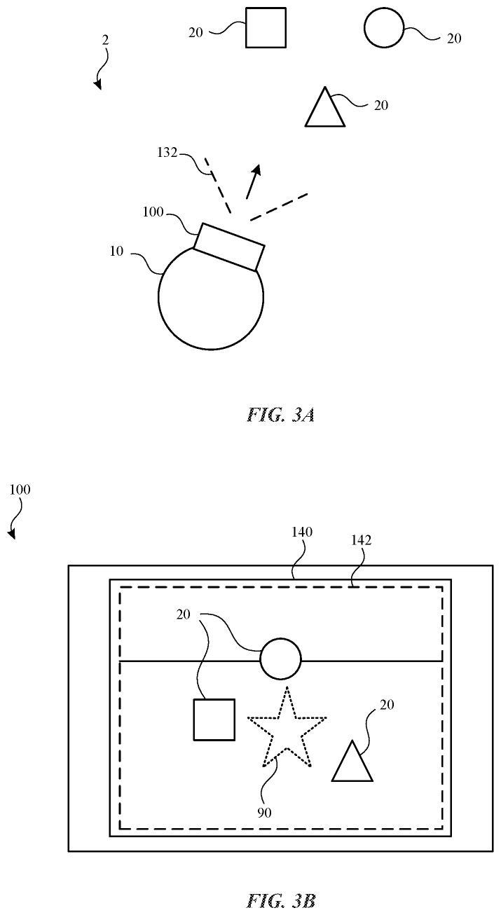

Referring now to FIGS. 3A and 3B, a head-mountable device can be operated to provide a visual output corresponding to physical objects and/or virtual objects. As shown in FIG. 3A, a first user 10 can wear and operate a head-mountable device 100. For example, the first user 10 can direct the head-mountable device 100 to capture an image of a field-of-view 132 that can include one or more physical objects 20. In some embodiments, one or more physical objects 20 can be captured by a camera or other sensor of the head-mountable device 100. Such physical objects 20 can form a basis for a visual output by one or more of the head-mountable device 100, as described further herein.

As shown in FIG. 3B, the head-mountable device 100 can provide an output that is based on a captured view. Such information can be provided within a graphical user interface. Regarding the graphical user interfaces described herein, not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided.

As further shown in FIG. 3B, the head-mountable device 100 can operate its display 140 to provide a graphical user interface 142. Both physical objects 20 and one or more virtual objects 90 can be visible within the display 140 as part of the graphical user interface 142. As further shown in FIG. 3B, the view of the virtual object(s) 90 and/or physical object(s) 20 can be based on the perspective of the head-mountable device 100. As such, the display 140 and/or the graphical user interface 142 can provide a view to particular sides and/or portions of the virtual object(s) 90 and/or physical object(s) 20.

As further shown in FIG. 3B, the first user interface 142 can include an image of the virtual object 90 based on a perspective captured by a camera or other sensor of the head-mountable device 100. In some embodiments, the virtual object 90 can be generated by the head-mountable device 100. The virtual object 90 can have a position and/or orientation with respect to the physical object(s) 20, such that the virtual object 90 appears within the field of view in which the physical object(s) 20 were captured.

It will be understood that, in some modes of operation, the first user 10 can be limited in an ability to share the output with another user. In particular, the virtual objects 90 based on corresponding content data can be visible to only the first user 10 wearing the head-mountable device 100. Accordingly, it can be desirable to share the view with another user without removing the head-mountable device 100 from the first user 10.

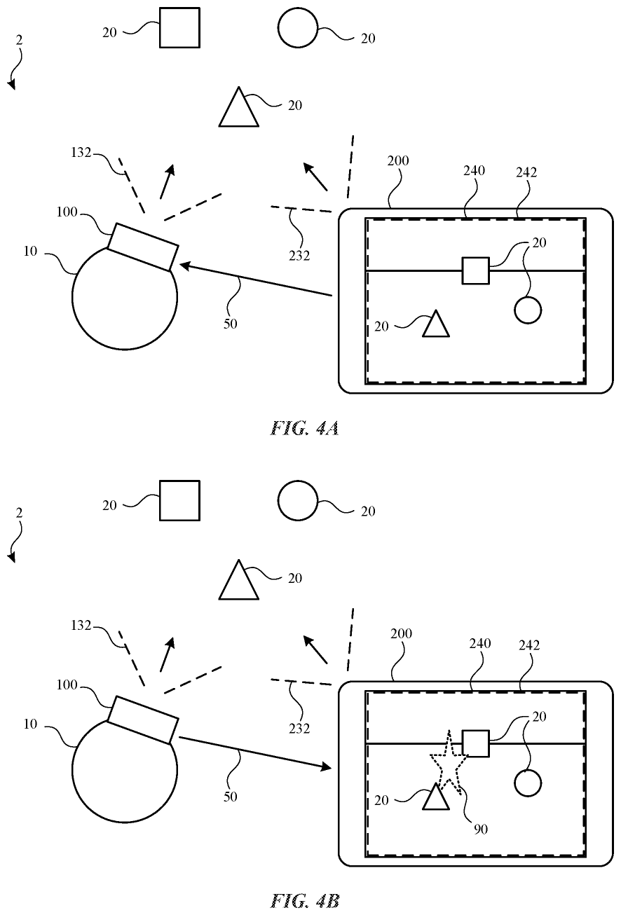

Referring now to FIGS. 4A and 4B, a head-mountable device can be operated in concert with another electronic device connected to the head-mountable device by a communication link. The operations of the head-mountable device and/or the electronic device can provide outputs to each of the users operating the corresponding devices.

As shown in FIG. 4A, a system 2 can include a first electronic device (e.g., head-mountable device 100 or another electronic device) and a second electronic device (e.g., electronic device 200 or another electronic device). It will be understood that the first electronic device and/or the second electronic device can be a head-mountable device and/or another electronic device. As such, while reference is made to head-mountable devices, the description provided herein can be applied to other electronic devices.

As shown in FIG. 4A, a first user 10 can wear and operate a head-mountable device 100, and another user (not shown) can hold, wear, observe, or otherwise operate an electronic device 200. For example, the first user 10 can direct the head-mountable device 100 to capture an image of a field-of-view 132 that can include one or more physical objects 20 and/or the electronic device 200. By further example, the second user can direct the electronic device 200 to capture an image of a field-of-view 232 that can include one or more of the same physical objects 20 as are within the field-of-view 132 captured by the head-mountable device 100. In some embodiments, the field-of-view 232 can optionally include the head-mountable device 100 therein. It will be understood that the system can include any number of users and corresponding head-mountable devices and/or electronic devices. The head-mountable devices and/or electronic devices can be provided with communication links between any pair of head-mountable devices and/or electronic devices for sharing data.

As further shown in FIG. 4A, the fields of view of the head-mountable device 100 and the electronic device 200 can overlap at least partially, such that an object (e.g., virtual object 90 and/or a physical object 20) is within a field of view of more than one of the devices. It will be understood that virtual objects (e.g., virtual object 90) need not be captured by a camera but can be within an output field of view (e.g., from displays 140 and/or 240) that is based on images captured by the corresponding camera. The head-mountable device 100 and the electronic device 200 can each be arranged to capture the object from a different perspective, such that different portions, surfaces, sides, and/or features of the virtual object 90 and/or physical objects 20 can be observed and/or displayed by the different devices. The physical object(s) 20 can form a basis for a visual output by one or more of the head-mountable device 100 and the electronic device 200, as described further herein.

As further shown in FIG. 4A, the electronic device 200 can operate its display 240 to provide a graphical user interface 242. In at least one mode of operation, the graphical user interface 242 can provide a view to physical objects 20. As further shown in FIG. 3A, the view of the physical object(s) 20 can be based on the perspective of the electronic device 200. As such, the display 240 and/or the graphical user interface 242 can provide a view to particular sides and/or portions of the physical object(s) 20.

In some embodiments, the electronic device 200 can transmit information regarding its position and orientation with respect to the head-mountable device 100, for example, as view data. For example, the electronic device 200 can capture the field-of-view 232, including one or more of the physical objects 20 and/or the head-mountable device 100 therein. Such information can be transmitted via the communication link 50 and to the head-mountable device 100, which can determine the position and/or orientation of the electronic device 200 with respect to the head-mountable device 100. Accordingly, the head-mountable device 100 can determine one or more features of the virtual object so that it can be displayed on a graphical user interface of the electronic device 200 in a manner that corresponds to the position and/or orientation of the virtual object with respect to the one or more physical objects 20.

Referring now to FIGS. 4B, the electronic device can provide corresponding outputs that reflect the perspective thereof and are based on content data received from the head-mountable device. Such information can be provided within a graphical user interface.

In some embodiments, the head-mountable device 100 can transmit information regarding one or more virtual objects 90 to the electronic device 200, for example, as content data. For example, the head-mountable device 100 can determine one or more features of the virtual object 90 based on the view data received from the electronic device 200. Such information can be transmitted via the communication link 50 and to the electronic device 200, which can use the content data to provide an output on the graphical user interface 242.

As shown in FIG. 4B, in another mode of operation of the electronic device 200, both physical objects 20 and the virtual objects 90 can be visible within the display 140 as part of the graphical user interface 142. The graphical user interface 242 can provide a different field of view than that of the graphical user interface 142 (see FIG. 3B). As further shown in FIG. 4B, the view of the virtual object 90 and/or a physical object 20 can be based on the view data and the content data. As such, the display 240 and/or the graphical user interface 242 can provide a view to particular sides and/or portions of the virtual object 90 and/or a physical object 20.

As further shown in FIG. 4B (and as compared to FIG. 3B), the head-mountable device 100 and the electronic device 200 can provided related content. The content can be at least partially based on the same source of generated content. The communication link 50 can be provided to facilitate communication between the multiple devices. The system 2 can include the communication link 50 that is configured to be operably connected to each of multiple electronic devices (e.g., head-mountable device 100 and electronic device 200). While separate, the head-mountable device 100 and the electronic device 200 can each be operated independently, for example while worn or held by separate users. While connected by the communication link 50, the head-mountable device 100 and the electronic device 200 can communicate with each other and be operated in concert. Accordingly, signals can be transmitted and received by each of the head-mountable device 100 and the electronic device 200 via the communication link 50.

As shown in FIG. 4B (and as compared to FIG. 3B), the second user interface 242 can also include content that is related to the content of the head-mountable device 100 (e.g., the image of the virtual object 90). However, the image of the virtual object 90 output by the electronic device 200 can be based on a perspective captured by a camera or other sensor of the electronic device 200. In some embodiments, the cameras and/or other sensors of the head-mountable device 100 and/or the electronic device 200 can determine the position and/or orientation of each of the head-mountable device 100 and/or the electronic device 200 with respect to the other of the head-mountable device 100, the electronic device 200, and/or another reference (e.g., other external device and/or physical object(s) 20 in the external environment). As such, the generation of content on each of the head-mountable device 100 and the electronic device 200 can be based on shared data (e.g., content relating to virtual objects 90) and/or the corresponding perspectives of each of the head-mountable device 100 and the electronic device 200.

In some embodiments, the virtual object 90 can be generated by the head-mountable device 100. The user wearing the head-mountable device 100 can choose to share the content relating to the virtual object 90 with the electronic device 200. For example, the user wearing the head-mountable device 100 can provide an input to the head-mountable device 100 that causes a signal to be transmitted along the communication link 50 to the electronic device 200. The signal can include an instruction to output the virtual object 90 on the user interface 242 of the electronic device 200. Additionally or alternatively, a user operating the electronic device 200 can request, accept, or otherwise provide an input to cause the virtual object 90 to be output on the user interface 242 of the electronic device 200.

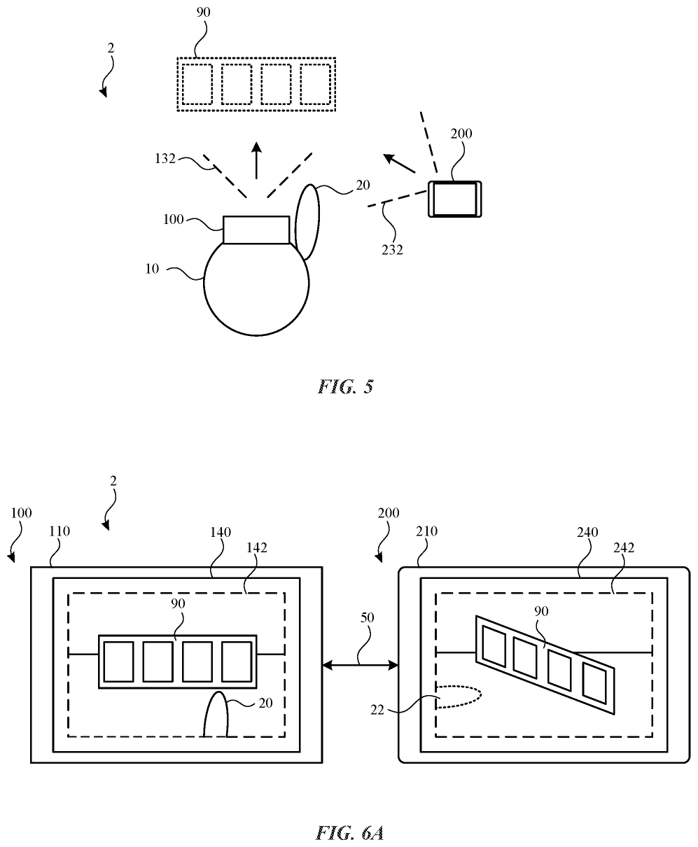

Referring now to FIGS. 5-8, a head-mountable device can be operated in concert with another electronic device connected to the head-mountable device by a communication link. The operations of the head-mountable device and/or the electronic device can provide outputs to each of the users operating the corresponding devices.

As shown in FIG. 5, a system 2 can include a first electronic device (e.g., head-mountable device 100 or another electronic device) and a second electronic device (e.g., electronic device 200 or another electronic device). It will be understood that the first electronic device and/or the second electronic device can be a head-mountable device and/or another electronic device. As such, while reference is made to head-mountable devices, the description provided herein can be applied to other electronic devices.

As shown in FIG. 5, a first user 10 can wear and operate a head-mountable device 100, and another user (not shown) can hold operate an electronic device 200. For example, the first user 10 can direct the head-mountable device 100 to capture an image of a field-of-view 132 that can include one or more physical objects 20 and/or the electronic device 200. By further example, the second user can direct the electronic device 200 to capture an image of a field-of-view 232 that can include one or more physical objects 20 and/or the head-mountable device 100. It will be understood that the system can include any number of users and corresponding head-mountable devices and/or electronic devices. The head-mountable devices and/or electronic devices can be provided with communication links between any pair of head-mountable devices and/or electronic devices for sharing data.

As further shown in FIG. 5, the fields of view of the head-mountable device 100 and the electronic device 200 can overlap at least partially, such that an object (e.g., virtual object 90 and/or a physical object 20) is within a field of view of more than one of the devices. It will be understood that virtual objects (e.g., virtual object 90) need not be captured by a camera but can be within an output field of view (e.g., from displays 140 and/or 240) that is based on images captured by the corresponding camera. The head-mountable device 100 and the electronic device 200 can each be arranged to capture the object from a different perspective, such that different portions, surfaces, sides, and/or features of the virtual object 90 and/or physical objects 20 can be observed and/or displayed by the different devices.

In some embodiments, one or more physical objects 20, such as a limb of a first user 10, can be captured by one or more of the head-mountable device 100 and the electronic device 200. Such a physical object 20 can form a basis for a visual output by one or more of the head-mountable device 100 and the electronic device 200, as described further herein.

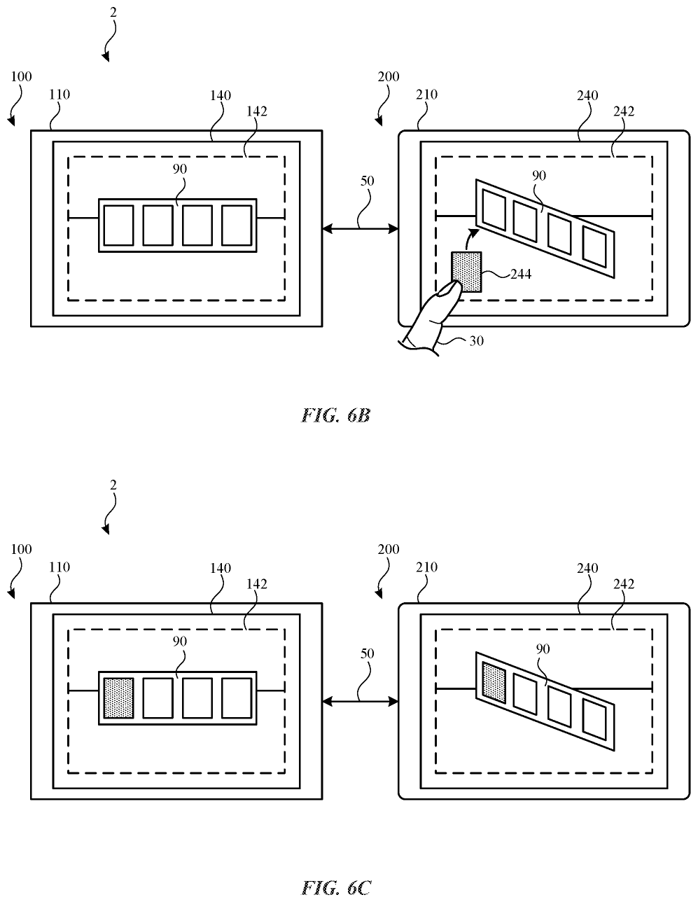

Referring now to FIGS. 6A-6C, the head-mountable device and the electronic device can provide corresponding outputs that reflect the perspectives thereof. Such information can be provided within graphical user interfaces.

As shown in FIG. 6A, the head-mountable device 100 can operate its display 140 to provide a graphical user interface 142. Both physical objects 20 and the virtual objects 90 can be visible within the display 140 as part of the graphical user interface 142. The graphical user interface 142 can occupy a substantial portion (e.g., up to all) of the display 140. As such, it can provide a different field of view than that of the graphical user interface 242. As further shown in FIG. 6A, the view of the virtual object 90 and/or a physical object 20 can be based on the perspective of the head-mountable device 100. As such, the display 140 and/or the graphical user interface 142 can provide a view to particular sides and/or portions of the virtual object 90 and/or a physical object 20.

As further shown in FIG. 6A, the electronic device 200 can operate its display 240 to provide a graphical user interface 242. The graphical user interface 242 can provide a view to physical objects 20 and/or the virtual object 90. As further shown in FIG. 6A, the view of the virtual object 90 and/or a physical object 20 can be based on the perspective of the electronic device 200. As such, the display 240 and/or the graphical user interface 242 can provide a view to particular sides and/or portions of the virtual object 90 and/or physical objects 20 that face the electronic device 200.

As shown in FIG. 6A, the first user interface 142 can include an image of the virtual object 90 based on a perspective captured by a camera or other sensor of the head-mountable device 100. The second user interface 242 can also include content that is related to the content of the first user interface 142 (e.g., the image of the virtual object 90). However, the image of the virtual object 90 output by the electronic device 200 can be based on a perspective captured by a camera or other sensor of the electronic device 200. In some embodiments, the cameras and/or other sensors of the head-mountable device 100 and/or the electronic device 200 can determine the position and/or orientation of each of the head-mountable device 100 and/or the electronic device 200 with respect to the other of the head-mountable device 100, the electronic device 200, and/or another reference (e.g., other external device and/or physical object(s) 20 in the external environment). As such, the generation of content on each of the head-mountable device 100 and the electronic device 200 can be based on shared data (e.g., content relating to virtual objects 90) and/or the corresponding perspectives of each of the head-mountable device 100 and the electronic device 200.

It will be understood that, despite common elements provided in both of the user interfaces 142 and 242 of the head-mountable device 100 and the electronic device 200 can be independently operated by the corresponding users in a manner that allows each user to adjust the view by moving and/or rotating the head-mountable device 100 and/or moving and/or rotating the electronic device 200. As such, a common set of content elements (e.g., an environment and/or virtual objects 90) can be independently experienced according to independent user actions. The visual output (e.g., with user interfaces) of each of the head-mountable device 100 and the electronic device 200 can be updated based on updated detections relating to the position and/or orientation of each of the head-mountable device 100 and the electronic device 200.

In some embodiments, the virtual object 90 can be generated by the head-mountable device 100. The user wearing the head-mountable device 100 can choose to share the content relating to the virtual object 90 with the electronic device 200. For example, the user wearing the head-mountable device 100 can provide an input to the head-mountable device 100 that causes a signal to be transmitted along the communication link 50 to the electronic device 200. The signal can include an instruction to output the virtual object 90 on the user interface 242 of the electronic device 200. Additionally or alternatively, a user operating the electronic device 200 can request, accept, or otherwise provide an input to cause the virtual object 90 to be output on the user interface 242 of the electronic device 200.

In some embodiments, the visual output of physical objects can differ between the head-mountable device 100 and electronic device 200. For example, the first user interface 142 of the head-mountable device 100 can provide visual output that includes both virtual objects 90 and physical objects 20. Information (e.g., as signals) relating to virtual object 90 can be communicated to the electronic device 200, as described herein. However, time may pass as such information is communicated to, processed by, and output on the electronic device 200. Accordingly, the visual output of virtual object 90 at the electronic device 200 can be based on information that is somewhat delayed with respect to visual output of physical objects that are directly detected by the electronic device 200. For example, if a user wearing the head-mountable device 100 interacts with a virtual object 90, the depiction of such an interaction on the electronic device 200 can be based on information that is directly detected and information that is communicated from the head-mountable device 100. As such, from the perspective of the user observing the electronic device 200, there may be discrepancies in the temporal experience (e.g., lag or latency) of virtual object 90 and physical objects 20.

The visual output of the physical object 20 can be different on the electronic device 200 that is on the head-mountable device 100. This can help the user observing the electronic device 200 focus on the virtual object 90 without being distracted by the physical object 20, which might otherwise be depicted in a manner that is not temporally synchronized with the virtual object 90.

In some embodiments, the electronic device 200 can detect a physical object 20 and omit the physical object from the user interface 242. It will be understood that omission of the physical object from the user interface 242 can be based on one or more criteria, such as proximity to the virtual object 90, identification of the physical object 20 as a portion of the first user 10, and the like. As such, only certain physical objects can be omitted from the user interface 242 based on designated criteria.

In some embodiments, the electronic device 200 can detect a physical object 20 and modify the physical object when depicted in the user interface 242. For example, the electronic device 200 can provide a visual output of a modified object 22 and the user interface 242. The modified object 22 can have one or more visual features that differ from the depiction of the physical object 20 in the first user interface 142 of the head-mountable device 100. For example, the modified object 22 can have a resolution, opacity, or other visual characteristic that is lower than that of the physical object 20 in the first user interface 142 and/or of the virtual object 90 in the user interface 242.

In some embodiments, the electronic device 200 can detect a physical object 20 and provide a representation of the physical object when depicted in the user interface 242. For example, the electronic device 200 can track a position, orientation, and/or motion of the physical object 20 and determine a predicted future position, orientation, and/or motion of the physical object 20. The modified object 22 can be provided as a representation of the physical object 20 in the predicted future position, orientation, and/or motion thereof. The modified object 22 can be repeatedly updated based on such detections.

In some embodiments, the electronic device 200 can detect a physical object 20 and provide additional visual features as an indication to the user when depicted in the user interface 242. For example, the modified object 22 can have a highlighting, glow, shadow, reflection, outline, border, text, icons, symbols, emphasis, duplication, aura, and/or animation provided at a vicinity thereof.

As shown in FIG. 6B, content can be modified on one or both of the devices based on user interactions. For example, a selectable feature 244 can be provided on the user interface 242 to indicate to the user operating the electronic device 200 a way to modify the virtual object 90. For example, a second user 30 can provide an input or otherwise performing a detectable action. Such an action can include interacting with the user interface 242 and/or another user input device of the electronic device 200. By further example, the second user may be operating a touch sensor of the electronic device 200 to interact with therewith and/or otherwise provide an indication of an item or area of interest. Such an operation with respect to a selectable feature 244 can be provided in response to a user input received at and/or an instruction transmitted from the head-mountable device 100, thereby allowing the second user 30 to make such modifications. In particular, the action of the virtual object 90 on the electronic device 200 can be based on information transmitted from the head-mountable device 100. As such, modifications to the virtual object 90 received that electronic device 200 can optionally be communicated to and managed by the head-mountable device 100.

As further shown in FIG. 6B, the second user 30 can provide one or more input types to modify the virtual object 90. For example, the second user 30 can interact with the selectable feature 244 output on the user interface 242. By further example, the second user 30 can interact with any other component of the electronic device 200. In some embodiments, the second user 30 can provide a gesture or other detectable motion. For example, the input can include a tap, double-tap, swipe, and the like. The detected characteristics of the input can determine both the type of modification to make and how such a modification is to be applied to the virtual object 90.

As shown in FIG. 6C, in response to the user inputs (e.g., provided by operation of the selectable feature 244), the virtual object 90 can be updated in both the first user interface 142 of the head-mountable device 100 and the user interface 242 of the electronic device 200. For example, the user input and/or an instruction associated therewith can be transmitted as a signal from the electronic device 200 to the head-mountable device 100. Accordingly, both the head-mountable device 100 and the electronic device 200 can update information with respect to the virtual object 90. The first user interface 142 and/or the second user interface 242 can be updated based on such information. It will be understood that each of the head-mountable device 100 and electronic device 200 can continue to provide visual output of the virtual object 90 based on the detected position and/or orientations of, respectively, the head-mountable device 100 and the electronic device 200. As such, while information relating to the virtual object 90 can be updated mutually, the individual perspectives of such content can differ based on other detectable conditions.

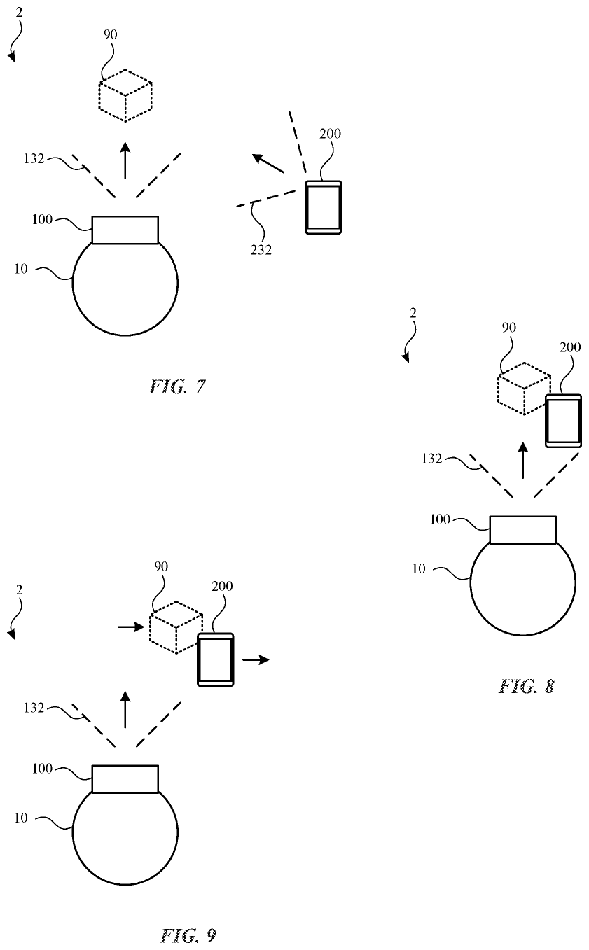

Referring now to FIGS. 7-9, a head-mountable device can be operated in concert with another electronic device to modify virtual content. The operations of the head-mountable device and/or the electronic device can provide outputs to each of the users operating the corresponding devices.

As shown in FIG. 7, a system 2 can include a first electronic device (e.g., head-mountable device 100 or another electronic device) and a second electronic device (e.g., electronic device 200 or another electronic device). It will be understood that the first electronic device and/or the second electronic device can be a head-mountable device and/or another electronic device. As such, while reference is made to head-mountable devices, the description provided herein can be applied to other electronic devices.

As shown in FIG. 7, a first user 10 can wear and operate a head-mountable device 100, and another user (not shown) can hold and operate an electronic device 200. For example, the first user 10 can direct the head-mountable device 100 to capture an image of a field-of-view 132 that can include one or more physical objects and/or the electronic device 200. By further example, the second user can direct the electronic device 200 to capture an image of a field-of-view 232 that can include one or more physical objects and/or the head-mountable device 100. It will be understood that the system can include any number of users and corresponding head-mountable devices and/or electronic devices. The head-mountable devices and/or electronic devices can be provided with communication links between any pair of head-mountable devices and/or electronic devices for sharing data.

As further shown in FIG. 7, the fields of view of the head-mountable device 100 and the electronic device 200 can overlap at least partially, such that an object (e.g., virtual object 90 and/or a physical object) is within a field of view of more than one of the devices. It will be understood that virtual objects (e.g., virtual object 90) need not be captured by a camera but can be within an output field of view that is based on images captured by the corresponding camera. The head-mountable device 100 and the electronic device 200 can each be arranged to capture the object from a different perspective, such that different portions, surfaces, sides, and/or features of the virtual object 90 and/or physical objects can be observed and/or displayed by the different devices.

As shown in FIG. 8, the electronic device 200 can be brought to a vicinity of the virtual object 90. For example, the electronic device 200 can have a distance with respect to the virtual object 90 that is within a threshold. While the electronic device 200 is an example of a physical device, it will be understood that the virtual object 90 can be an object that is not in a physical environment. As such, the proximity of the electronic device 200 with respect to the virtual object 90 can be determined with reference to where each item is in a virtual space. Such proximity can be observed through the displays of either the head-mountable device 100 and/or the electronic device 200. Additionally or alternatively, the electronic device 200 can be operated to receive a user input corresponding to an operation to modify the virtual object 90 with the electronic device 200. For example, the user can operate electronic device 200 (e.g., with a user input device thereof) to provide a user input that indicates a desire to modify the virtual object 90. It will be understood that multiple criteria can be provided and satisfied for modifying the virtual object 90 with electronic device 200, such as proximity and/or user input.

In some embodiments, the electronic device 200 can provide an output (e.g., feedback) to indicate receipt of the user input and/or proximity to the virtual object 90. For example, when the electronic device 200 is brought to within a threshold distance with respect to the virtual object 90, the electronic device 200 can provide one or more outputs. By further example, when the electronic device 200 receives the user input, the electronic device 200 can provide one or more outputs. Such outputs can include haptic feedback, a sound, and/or a visual output. Based on the output and/or feedback, the user can be informed that further operations of the electronic device 200 can modify the virtual object 90.

As shown in FIG. 9, the electronic device 200 can be moved or otherwise operated to provide user input. In response to such user inputs, the head-mountable device 100 and/or the electronic device 200 can modify the virtual object 90. For example, the electronic device 200 can be moved within the environment, and the virtual object 90 can be moved along with the electronic device 200. By further example, the electronic device 200 can be operated to provide one or more other modifications to the virtual object 90. By further example, the electronic device 200 can be operated to generate one or more virtual objects. By further example, the electronic device 200 can be operated to remove, delete, or omit one or more virtual objects. Such modification to virtual objects 90 and/or other operations can be used as a basis to update the outputs (e.g., visual outputs) of the head-mountable device 100 and/or the electronic device 200.

In some embodiments, the operations of the electronic device 200 with respect to one or more virtual objects can be terminated. For example, the electronic device 200 can receive a user input to end a modification session. By further example, the head-mountable device 100 can receive a user input to end a modification session.

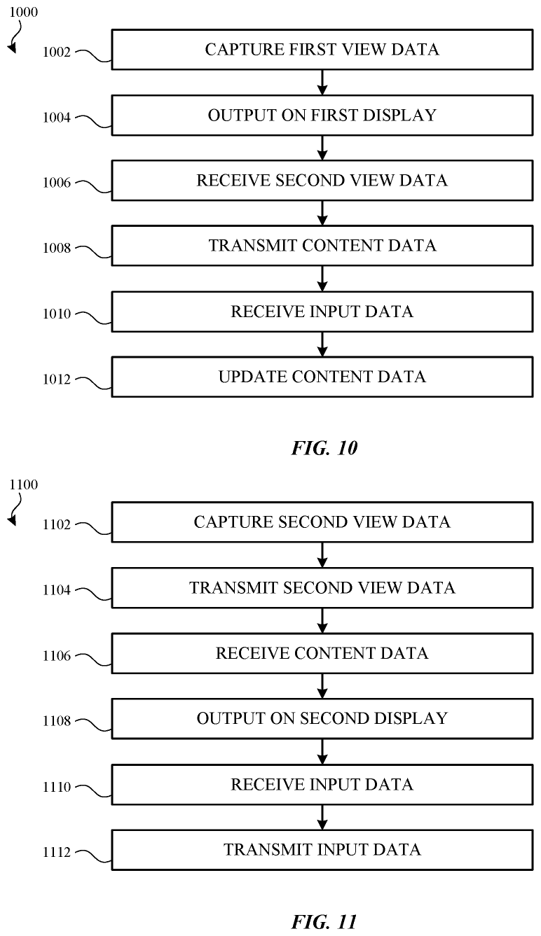

FIG. 10 illustrates a flow diagram for operating a head-mountable device. For explanatory purposes, the process 1000 is primarily described herein with reference to the head-mountable device 100 of FIGS. 1 and 3-9. However, the process 1000 is not limited to the head-mountable device 100 of FIGS. 1 and 3-9, and one or more blocks (or operations) of the process 1000 may be performed by different head-mountable devices and/or one or more other devices. Further for explanatory purposes, the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

In operation 1002, a head-mountable device can capture first view data corresponding to an observed perspective of the head-mountable device. For example, the first view data can include information relating to one or more images captured by a camera of the head-mountable device. In some embodiments, the first view data can be received from another device that can be used to determine a position and/or orientation of the head-mountable device within a space. Accordingly, the first view data can include information relating to the position and/or orientation of the head-mountable device with respect to a physical object and/or a virtual object to be rendered. The first view data can further include information relating to one or more physical objects observed by the head-mountable device.

In operation 1004, the head-mountable device can provide an output on a display thereof. For example, the display can output a view of one or more virtual and/or physical objects with the display and/or a graphical user interface provided thereon, such as that illustrated in FIGS. 4-6. The output provided on the display can be based at least in part on the first view data captured by the head-mountable device, which can thereby determine the sides and/or portions of virtual and/or physical objects that are observable based on the output provided by the display.

In operation 1006, the head-mountable device can receive view data from the electronic device, which can include information regarding its position and orientation with respect to the head-mountable device 100 and/or one or more physical objects. The head-mountable device can determine one or more features of a virtual object so that it can be displayed on a graphical user interface of the electronic device in a manner that corresponds to the position and/or orientation of the virtual object with respect to the one or more physical objects.

In operation 1008, the content data can be transmitted to an electronic device. The transmission can be made in response to a user input authorizing such transmission to the electronic device. In this regard, the content data can include data that was used by the head-mountable device for providing an output on the first display in operation 1004, such as information relating to a virtual object or other content. Additionally or alternatively, the content data can include information, images, and/or other data that is generated based on the first view data.

In operation 1010, input data can be received from the electronic device. For example, the input data can include a modification to a virtual object or other content.

In operation 1012, the head-mountable device can update the content data. For example, the head-mountable device can update any output on the first display that is based on the modified content data. Such an update can also include updated first view data. In this regard, the process 1000 can be repeated to provide repeated or continual updates.

FIG. 11 illustrates a flow diagram for operating an electronic device. For explanatory purposes, the process 1100 is primarily described herein with reference to the electronic device 200 of FIGS. 2-9. However, the process 1100 is not limited to the electronic device 200 of FIGS. 2-9, and one or more blocks (or operations) of the process 1100 may be performed by different head-mountable devices and/or one or more other devices. Further for explanatory purposes, the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

In operation 1102, an electronic device can capture second view data corresponding to an observed perspective of the electronic device. For example, the second view data can include information relating to one or more images captured by a camera of the electronic device. In some embodiments, the second view data can be received from another device that can be used to determine a position and/or orientation of the electronic device within a space. Accordingly, the second view data can include information relating to the position and/or orientation of the electronic device with respect to a physical object and/or a virtual object to be rendered. The second view data can further include information relating to one or more physical objects observed by the electronic device.

In operation 1104, the electronic device can transmit view data to the head-mountable device, which can include information regarding its position and orientation with respect to the head-mountable device and/or one or more physical objects.

In operation 1106, content data can be received from the head-mountable device. The content data can be used, for example with the second view data, by the electronic device to determine the position and/or orientation of the head-mountable device with respect to the electronic device and/or a virtual or physical object. The content data can further be used to determine information relating to the perspective of the head-mountable device.

In operation 1108, the electronic device can provide an output on a display thereof. For example, the display can output a view of one or more virtual and/or physical objects with the display and/or a graphical user interface provided thereon, such as that illustrated in FIGS. 4-6. The output provided on the display can be based at least in part on the second view data captured by the electronic device and/or the content data. The output can further include a selectable feature or other option for receiving a user input.

In operation 1110, the electronic device can receive input data. For example, the electronic device can detect a user input, such as operation of a selectable feature output by the electronic device. By further example, the input data can include a movement or other input at the electronic device indicating a modification to a virtual object or other content based on operation of the electronic device.

In operation 1112, the input data can be transmitted to the head-mountable device. The head-mountable device and the electronic device can update the content data. For example, the electronic device can update any output on the second display that is based on the modified content data. Such an update can also include updated second view data. In this regard, the process 1100 can be repeated to provide repeated or continual updates.

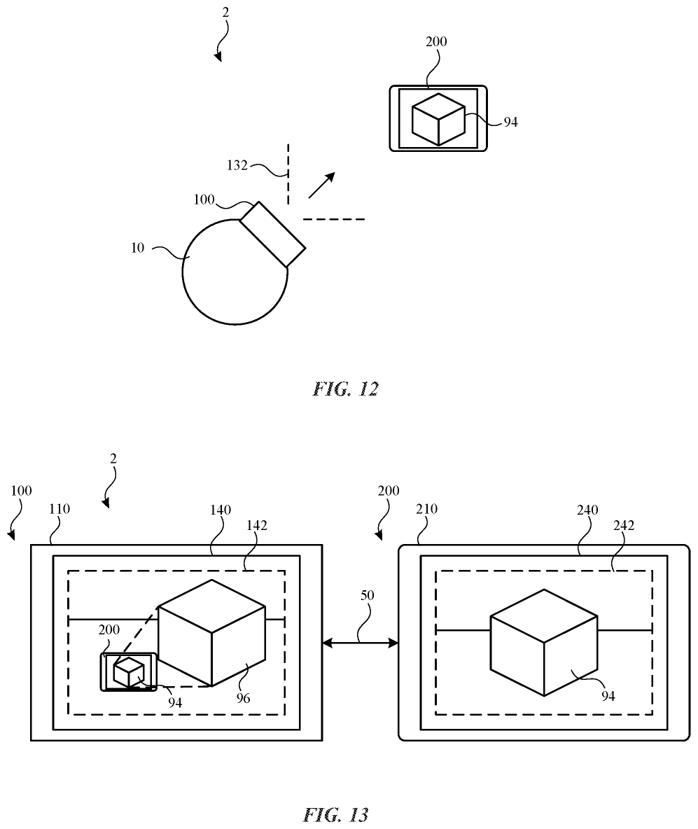

Referring now to FIGS. 12 and 13, a head-mountable device can be operated in concert with another electronic device to provide a view of shared content. The operations of the head-mountable device and/or the electronic device can provide outputs to each of the users operating the corresponding devices.

As shown in FIG. 12, a system 2 can include a first electronic device (e.g., head-mountable device 100 or another electronic device) and a second electronic device (e.g., electronic device 200 or another electronic device). It will be understood that the first electronic device and/or the second electronic device can be a head-mountable device and/or another electronic device. As such, while reference is made to head-mountable devices, the description provided herein can be applied to other electronic devices.

As shown in FIG. 12, a first user 10 can wear and operate a head-mountable device 100, and another user (not shown) can hold and operate an electronic device 200. For example, the first user 10 can direct the head-mountable device 100 to capture an image of a field-of-view 132 that can include one or more physical objects, including the electronic device 200. The electronic device 200 can be operated to provide one or more outputs, such as a visual feature 94. It will be understood that the system can include any number of users and corresponding head-mountable devices and/or electronic devices. The head-mountable devices and/or electronic devices can be provided with communication links between any pair of head-mountable devices and/or electronic devices for sharing data.

As shown in FIG. 13, the head-mountable device 100 and the electronic device 200 can provide corresponding outputs that reflect the perspectives thereof. Such information can be provided within graphical user interfaces. For example, the electronic device 200 can operate its display 240 to provide a graphical user interface 242. The graphical user interface 242 can provide a view of a visual feature 94. The visual feature 94 can be based on any output of the electronic device 200, such as an application, media (images, video, etc.), web content, a document, and the like.

As further shown in FIG. 13, the head-mountable device 100 can operate its display 140 to provide a graphical user interface 142. The electronic device 200 and its visual output can be visible within the display 140 as part of the graphical user interface 142. As further shown in FIG. 13, the view of the electronic device 200 and the visual feature 94 can be based on the perspective of the head-mountable device 100 with respect to the electronic device 200.

As further shown in FIG. 13, the head-mountable device 100 and the electronic device 200 can share outputs so that each of the users are presented with related content. The content can be at least partially based on the same source of generated content. A communication link 50 can be provided to facilitate communication between multiple devices. The system 2 can include the communication link 50 that is configured to be operably connected to each of multiple electronic devices (e.g., head-mountable device 100 and electronic device 200). While separate, the head-mountable device 100 and the electronic device 200 can each be operated independently, for example while worn or held by separate users. While connected by the communication link 50, the head-mountable device 100 and the electronic device 200 can communicate with each other and be operated in concert. Accordingly, signals can be transmitted and received by each of the head-mountable device 100 and the electronic device 200 via the communication link 50.

As shown in FIG. 13, the first user interface 142 can include an image of the electronic device 200 based on a perspective captured by a camera or other sensor of the head-mountable device 100. In some embodiments, the cameras and/or other sensors of the head-mountable device 100 can determine the position and/or orientation of each of the head-mountable device 100 and/or the electronic device 200 with respect to the other of the head-mountable device 100, the electronic device 200, and/or another reference (e.g., other external device and/or physical object(s) 20 in the external environment). As such, the generation of content on each of the head-mountable device 100 can be based on shared data (e.g., content relating to the visual feature 94) and/or the corresponding perspectives of each of the head-mountable device 100 and the electronic device 200.

The first user interface 142 can also include content that is related to the content of the second user interface 242 (e.g., the visual feature 94). In some embodiments, the first user interface 142 can provide the view of the electronic device 200, including the visual feature 94 thereon. The view of the electronic device 200 and the visual feature 94 can be based on the image captured by the head-mountable device 100. In some embodiments, the output of the visual feature 94 within the first user interface 142 can be enhanced by generating the output thereof based on the content data, rather than exclusively relying on images captured by the head-mountable device 100. For example, the content data received from the electronic device 200 can be applied to provide an output of the visual feature 94 at the location of the electronic device 200. Such an output can be overlaid on top of the image captured by the head-mountable device 100. The output of the visual feature 94 (e.g., as an overlay) can be updated based on the position and/or orientation of the electronic device 200 and/or changes thereto. Such an output can provide the visual feature 94 with greater resolution and fidelity (with respect to the original output of the visual feature 94 on the on the second user interface 242 electronic device 200) than would be output on the first user interface 142 based solely on the image captured by a camera of the head-mountable device 100.

In some embodiments, the first user interface 142 can further provide a modified feature 96. The modified feature 96 can be based on the visual feature 94 output by the electronic device 200. For example, the modified feature 96 can include an enlargement, magnification, or other modified depiction of the visual feature 94. The modified feature 96 can include all or a portion of the visual feature 94. As such, the modified feature can provide an enhanced view for the user wearing the head-mountable device 100 than would be provided based solely on the view of the electronic device 200.

In some embodiments, the modified feature 96 can be presented in the first user interface 142 at a location that corresponds to a location of the electronic device 200. For example, the modified feature 96 can be presented within a distance of the electronic device 200 in the first user interface 142. By further example, the modified feature 96 can at least partially overlap the electronic device 200 in the first user interface 142. By further example, the modified feature 96 can be on a side of the electronic device 200 in the first user interface 142.

In some embodiments, the modified feature 96 can be altered, controlled, and/or managed by the user wearing the head-mountable device 100. For example, regardless, of the position and/or orientation of the electronic device 200, the modified feature 96 can be moved, re-oriented, or otherwise altered in response to a user input at the head-mountable device 100.

In some embodiments, the modified feature 96 can be provided in a manner that enhances observation by a user. For example, the modified feature 96 can be presented as a virtual object in a two-dimensional plane of the virtual space, the plane facing and/or being orthogonal to the user's line of vision. This can help present the content of the modified feature 96 with less distortion than may be presented on the second user interface 242 electronic device 200, which may be based on the position and/or orientation of the electronic device 200.

It will be understood that, despite common elements provided in both of the user interfaces 142 and 242 of the head-mountable device 100 and the electronic device 200 can be independently operated by the corresponding users in a manner that allows each user to adjust the view by moving and/or rotating the head-mountable device 100 and/or moving and/or rotating the electronic device 200. As such, a common set of content elements (e.g., an environment and/or the visual feature 94) can be independently experienced according to independent user actions. The visual output (e.g., with user interfaces) of each of the head-mountable device 100 and the electronic device 200 can be updated based on updated detections relating to the position and/or orientation of each of the head-mountable device 100 and the electronic device 200.

In some embodiments, the visual feature 94 can be generated by the electronic device 200. The user operating the electronic device 200 can choose to share the content relating to the visual feature 94 with the head-mountable device 100. For example, the user operating the electronic device 200 can provide an input to the electronic device 200 that causes a signal to be transmitted along the communication link 50 to the head-mountable device 100. The signal can include an instruction to output the visual feature 94 on the first user interface 142 of the head-mountable device 100. Additionally or alternatively, a user operating the head-mountable device 100 can request, accept, or otherwise provide an input to cause the visual feature 94 to be output on the first user interface 142 of the head-mountable device 100.

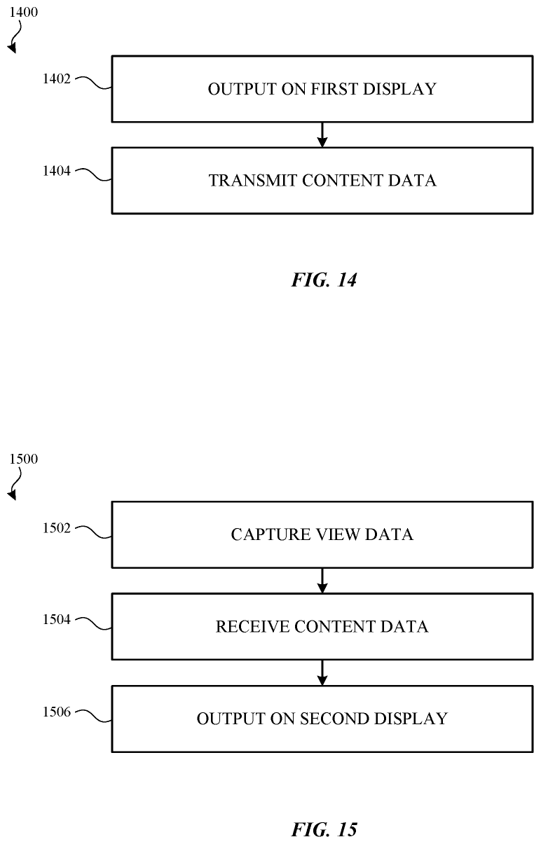

FIG. 14 illustrates a flow diagram for operating an electronic device. For explanatory purposes, the process 1400 is primarily described herein with reference to the electronic device 200 of FIGS. 12 and 13. However, the process 1400 is not limited to the electronic device 200 of FIGS. 12 and 13, and one or more blocks (or operations) of the process 1400 may be performed by different electronic devices and/or one or more other devices. Further for explanatory purposes, the blocks of the process 1400 are described herein as occurring in serial, or linearly. However, multiple blocks of the process 1400 may occur in parallel. In addition, the blocks of the process 1400 need not be performed in the order shown and/or one or more blocks of the process 1400 need not be performed and/or can be replaced by other operations.

In operation 1402, the electronic device can provide an output on a display thereof. For example, the display can output a view of one or more visual features with the display and/or a graphical user interface provided thereon, such as that illustrated in FIG. 13.

In operation 1404, the content data can be transmitted to a head-mountable device. The transmission can be made in response to a user input authorizing such transmission to the head-mountable device. In this regard, the content data can include data that was used by the electronic device for providing an output on the first display in operation 1402, such as information relating to a visual feature or other content.

FIG. 15 illustrates a flow diagram for operating a head-mountable device. For explanatory purposes, the process 1500 is primarily described herein with reference to the head-mountable device 100 of FIGS. 12 and 13. However, the process 1500 is not limited to the head-mountable device 100 of FIGS. 12 and 13, and one or more blocks (or operations) of the process 1500 may be performed by different electronic devices and/or one or more other devices. Further for explanatory purposes, the blocks of the process 1500 are described herein as occurring in serial, or linearly. However, multiple blocks of the process 1500 may occur in parallel. In addition, the blocks of the process 1500 need not be performed in the order shown and/or one or more blocks of the process 1500 need not be performed and/or can be replaced by other operations.

In operation 1502, a head-mountable device can capture view data corresponding to an observed perspective of the head-mountable device. For example, the view data can include information relating to one or more images captured by a camera of the head-mountable device. In some embodiments, the view data can be received from another device that can be used to determine a position and/or orientation of the head-mountable device within a space. Accordingly, the view data can include information relating to the position and/or orientation of the head-mountable device with respect to a physical object and/or a virtual object to be rendered. The view data can further include information relating to one or more physical objects observed by the head-mountable device.

In operation 1504, content data can be received from the electronic device. The content data can be used, for example with the view data, by the head-mountable device to determine the position and/or orientation of the electronic device with respect to the head-mountable device and/or a virtual or physical object. The content data can further be used to determine information relating to the perspective of the electronic device.

In operation 1506, the head-mountable device can provide an output on a display thereof. For example, the display can output a view of one or more physical objects with the display and/or a graphical user interface provided thereon, such as a view of the electronic device and/or a modified feature based on the received content data. By further example, the display can output a view of one or more virtual and/or physical objects with the display and/or a graphical user interface provided thereon, such as that illustrated in FIGS. 13. The output provided on the display can be based at least in part on the view data captured by the head-mountable device and/or the content data. The output can further include a selectable feature or other option for receiving a user input.

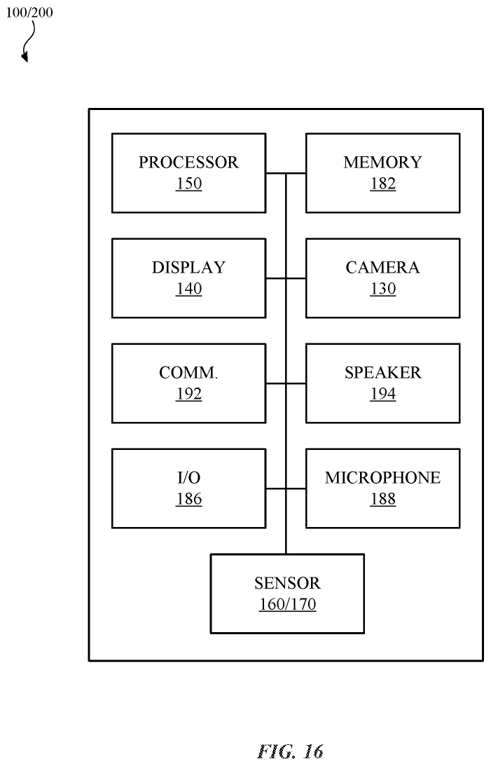

Referring now to FIG. 16, components of the head-mountable device, electronic device, and/or external device can be operably connected to provide the performance described herein. FIG. 16 shows a simplified block diagram of an illustrative head-mountable device 100 and/or electronic device 200 in accordance with embodiments of the present disclosure. It will be understood that additional components, different components, or fewer components than those illustrated may be utilized within the scope of the subject disclosure.

As shown in FIG. 16, the head-mountable device 100 and/or electronic device 200 can include a processor 150 (e.g., control circuitry) with one or more processing units that include or are configured to access a memory 182 having instructions stored thereon. The instructions or computer programs may be configured to perform one or more of the operations or functions described with respect to the head-mountable device 100 and/or electronic device 200. The processor 150 can be implemented as any electronic device capable of processing, receiving, or transmitting data or instructions. For example, the processor 150 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 182 can store electronic data that can be used by the head-mountable device 100 and/or electronic device 200. For example, the memory 182 can store electrical data or content such as, for example, audio and video files, documents and applications, device settings and user preferences, timing and control signals or data for the various modules, data structures or databases, and so on. The memory 182 can be configured as any type of memory. By way of example only, the memory 182 can be implemented as random access memory, read-only memory, Flash memory, removable memory, or other types of storage elements, or combinations of such devices.

The head-mountable device 100 and/or electronic device 200 can further include a display 140 for displaying visual information for a user. The display 140 can provide visual (e.g., image or video) output. The display 140 can be or include an opaque, transparent, and/or translucent display. The display 140 may have a transparent or translucent medium through which light representative of images is directed to a user's eyes. The display 140 may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. The head-mountable device 100 and/or electronic device 200 can include an optical subassembly configured to help optically adjust and correctly project the image-based content being displayed by the display 140 for close up viewing. The optical subassembly can include one or more lenses, mirrors, or other optical devices.

The head-mountable device 100 and/or electronic device 200 can include one or more sensors 160 and/or 170, as described herein. The head-mountable device 100 and/or electronic device 200 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc. Sensors can include a camera which can capture image-based content of the outside world.

The head-mountable device 100 and/or electronic device 200 can include an input/output component 186, which can include any suitable component for connecting head-mountable device 100 and/or electronic device 200 to other devices. Suitable components can include, for example, audio/video jacks, data connectors, or any additional or alternative input/output components. The input/output component 186 can include buttons, keys, or another feature that can act as a keyboard for operation by the user.

The head-mountable device 100 and/or electronic device 200 can include the microphone 188 as described herein. The microphone 188 can be operably connected to the processor 150 for detection of sound levels and communication of detections for further processing, as described further herein.

The head-mountable device 100 and/or electronic device 200 can include speakers 194. The speakers 194 can be operably connected to the processor 150 for control of speaker output, including sound levels, as described further herein.

The head-mountable device 100 and/or electronic device 200 can include communications circuitry 192 for communicating with one or more servers or other devices using any suitable communications protocol. For example, communications circuitry 192 can support Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 192 can also include an antenna for transmitting and receiving electromagnetic signals.

The head-mountable device 100 and/or electronic device 200 can include a battery or other power source, which can charge and/or power components of the head-mountable device 100 and/or electronic device 200. The battery can also charge and/or power components connected to the head-mountable device 100 and/or electronic device 200.

Accordingly, systems of the present disclosure can provide head-mountable devices and other electronic devices with different input and output capabilities. Such differences can lead the head-mountable devices and other electronic devices to provide the corresponding users with somewhat isolating experiences despite operating in a shared environment. However, the outputs provided by one head-mountable device or one electronic device can be shared on another device so that the users are aware of each other's experience. At least some content provided for output on one device can be transmitted to another device for output thereat. Such content can be provided in a manner that allows the user of the other electronic device to have a different perspective and/or experience with respect to the content.

Various examples of aspects of the disclosure are described below as clauses for convenience. These are provided as examples, and do not limit the subject technology.

Clause A: an electronic device comprising: a camera; a first display; a user interface device; a communication interface for communicating with a head-mountable device; and a processor configured to: receive, from the head-mountable device and via the communication interface, a first signal indicating a virtual object in a first image output on a second display of the head-mountable device; capture, with the camera, a second image; output, on the first display, the second image including the virtual object, wherein a location of the virtual object on the first display is based on a location of the virtual object on the second display, the second image further including a visual feature based on the virtual object; receive, with the user interface device, a user input provided with respect to the visual feature; and transmit, to the head-mountable device and via the communication interface, a second signal comprising an instruction to modify, in response to the user input, the virtual object in the first image while the first image is output on the second display of the head-mountable device.

Clause B: an electronic device comprising: a camera; a first display; a communication interface for communicating with a head-mountable device; and a processor configured to: receive, from the head-mountable device and via the communication interface, a signal indicating a virtual object and a first visual feature in a first image output on a second display of the head-mountable device, the first visual feature being based on a physical object; capture, with the camera, a second image including the physical object; and output, on the first display, the second image including the virtual object and a second visual feature, wherein a location of the virtual object on the first display is based on a location of the virtual object on the second display, wherein the second visual feature is based on the physical object, and wherein the second visual feature is modified relative to the first visual feature.

Clause C: a head-mountable device comprising: a camera; a first display; a communication interface for communicating with an electronic device; and a processor configured to: capture, with the camera, an image of the electronic device, the electronic device comprising a second display configured to present a first visual feature; receive, from the electronic device and via the communication interface, a signal indicating the first visual feature presented on the second display of the electronic device; and determine a second visual feature as a modification of the first visual feature; and output, on the first display, the image of the electronic device with the second visual feature, wherein a location of the second visual feature on the first display is based on a location of the electronic device on the first display.

One or more of the above clauses can include one or more of the features described below. It is noted that any of the following clauses may be combined in any combination with each other, and placed into a respective independent clause, e.g., clause A, B, or C.

Clause 1: the processor is further configured to, in response to the user input, update the virtual object and the visual feature on the first display.

Clause 2: the visual feature is a first visual feature; the first image includes a second visual feature based on a physical object; and the second image omits the second visual feature.

Clause 3: the visual feature comprises a menu of selectable operations.

Clause 4: each of the selectable operations corresponds to a selectable modification to the virtual object.

Clause 5: the user input comprises a gesture on the first display from the menu to the virtual object.

Clause 6: the visual feature comprises a depiction of the virtual object that is maintained in a constant position and orientation on the first display throughout movement of the virtual object across the first display.

Clause 7: each of the first visual feature and the second visual feature is a rendering based on the physical object.

Clause 8: in the second image, the second visual feature has a resolution that is lower than a resolution of the virtual object.

Clause 9: in the second image, the second visual feature has a brightness that is lower than a brightness of the virtual object.

Clause 10: the processor is further configured to: receive a user input provided with respect to the virtual object on the first display; and transmit, to the head-mountable device and via the communication interface, an additional signal comprising an instruction to modify, in response to the user input, the virtual object in the first image while the first image is output on the second display of the head-mountable device.

Clause 11: the second visual feature is an enlargement of the first visual feature.

Clause 12: the signal from the electronic device is generated in response to a user input at the electronic device.

Clause 13: the location of the second visual feature on the first display is overlapping the location of the electronic device on the first display.

Clause 14: a user interface device configured to receive a user input, wherein the processor is further configured to change the location of the second visual feature on the first display in response to the user input.

Clause 15: the user interface device is a touch sensor configured to detect a touch input.

Clause 16: the user interface device is an orientation sensor configured to detect an orientation of the head-mountable device with respect to the electronic device.

Clause 17: the signal is a first signal; and the head-mountable device further comprises a user interface device configured to receive a user input, wherein the processor is further configured to: receive the user input; and transmit, to the electronic device and via the communication interface, a second signal comprising an instruction to modify the first visual feature on the second display of the electronic device.

As described above, one aspect of the present technology may include the gathering and use of data available from various sources. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An electronic device comprising:
a camera configured to capture an image;
a first display;
a communication interface for communicating with a head-mountable device; and
a processor configured to:
transmit view data indicating a position and orientation of the electronic device, the view data being based on the image captured by the camera;
receive, from the head-mountable device and via the communication interface, content data indicating a position of a virtual object with respect to the electronic device, the content data being generated by the head-mountable device based on the view data; and
output, on the first display and based on the content data, the image including the virtual object, wherein a location of the virtual object on the first display is based on the position of the virtual object with respect to the head-mountable device, the image further including a visual feature corresponding to the virtual object.

2. The electronic device of claim 1, further comprising a user interface device, wherein the processor is further configured to:
receive, with the user interface device, a user input provided with respect to the visual feature; and
transmit, to the head-mountable device and via the communication interface, input data comprising an instruction to modify, in response to the user input, the virtual object while the virtual object is output on a second display of the head-mountable device.

3. The electronic device of claim 2, wherein the processor is further configured to, in response to the user input, update the virtual object and the visual feature on the first display.

4. The electronic device of claim 2, wherein:
the visual feature is a first visual feature;
an output on the second display of the head-mountable device includes a second visual feature based on a physical object; and
when the physical object is within a threshold distance of the virtual object, the processor is further configured to output the image with a modified object corresponding to the physical object.

5. The electronic device of claim 2, wherein the visual feature comprises a menu of selectable operations.

6. The electronic device of claim 5, wherein each of the selectable operations corresponds to a selectable modification to the virtual object.

7. The electronic device of claim 5, wherein the user input comprises a gesture on the first display from the menu to the virtual object.

8. An electronic device comprising:
a camera;
a display;
a communication interface for communicating with a head-mountable device; and
a processor configured to:
receive, from the head-mountable device and via the communication interface, content data indicating a position of a virtual object with respect to the head-mountable device;
capture, with the camera, an image including a view of a physical object; and
output, on the display, the image including:
the virtual object, wherein a location of the virtual object on the display is based on the position of the virtual object with respect to the head-mountable device; and
a visual feature based on the physical object, wherein the visual feature is modified relative to the view of the physical object when the physical object is within a threshold distance with respect to the virtual object.

9. The electronic device of claim 8, wherein, in the image, the visual feature has a resolution that is lower than a resolution of the virtual object.

10. The electronic device of claim 8, wherein, in the image, the visual feature has a brightness that is lower than a brightness of the virtual object.

11. The electronic device of claim 8, wherein the processor is further configured to:
receive a user input provided with respect to the virtual object on the display; and
transmit, to the head-mountable device and via the communication interface, input data comprising an instruction to modify, in response to the user input, the virtual object in the image while an additional image is output on an additional display of the head-mountable device.

12. A head-mountable device comprising:
a camera;
a first display;
a communication interface for communicating with an electronic device; and
a processor configured to:
capture, with the camera, an image of the electronic device, the electronic device comprising a second display configured to present a first visual feature;
receive, from the electronic device and via the communication interface, content data indicating the first visual feature presented on the second display of the electronic device; and
determine a second visual feature as a modification of the first visual feature; and
output, on the first display, the image including the electronic device and the second visual feature.

13. The head-mountable device of claim 12, wherein a location of the second visual feature on the first display is based on a location of the electronic device on the first display.

14. The head-mountable device of claim 13, wherein the location of the second visual feature on the first display is overlapping the location of the electronic device on the first display.

15. The head-mountable device of claim 12, wherein the second visual feature is an enlargement of the first visual feature.

16. The head-mountable device of claim 12, wherein the content data from the electronic device is transmitted in response to a user input at the electronic device.

17. The head-mountable device of claim 12, further comprising a user interface device configured to receive a user input, wherein the processor is further configured to change a location of the second visual feature on the first display in response to the user input.

18. The head-mountable device of claim 17, wherein the user interface device is a touch sensor configured to detect a touch input.

19. The head-mountable device of claim 17, wherein the user interface device is an orientation sensor configured to detect an orientation of the head-mountable device with respect to the electronic device.

20. The head-mountable device of claim 12, further comprising a user interface device configured to receive a user input, wherein the processor is further configured to:
receive the user input; and
transmit, to the electronic device and via the communication interface, input data comprising an instruction to modify the first visual feature on the second display of the electronic device based on the user input.
